(19) United States
(12) Patent Application Publication
(10) Pub. No.: US 2005/0125365 A1
(43) Pub. Date: Jun. 9, 2005

(54) Apparatus for automatic determination of a product description for display by means of a mail-processing device

(75) Inventor: Katrin Reisinger, Oranienburg (DE)

Correspondence Address: SCHIFF HARDIN, LLP;PATENT DEPARTMENT, 6600 SEARS TOWER, CHICAGO, IL, 60606-6473, US

(73) Assignee: Francotyp Postalia AG & Co. KG

(21) Appl. No.: 10/797,838

(22) Filed: Mar. 10, 2004

(30) Foreign Application Priority Data
Dec. 4, 2003 (DE) 203 18 751.2

(51) Int. Cl. G06F 17/60

(52) U.S. Cl. 705/401

(57) ABSTRACT

A mail-processing device that undertakes automatic generation of a product description has a programmable memory, a program memory, a working memory, a keyboard with operating elements, and a microprocessor, wherein either the program memory or the programmable memory has a memory range containing a program for evaluating mail-item-related data values stored in the working memory for permanent of semi-permanent storage of those values, and a memory range or semi-permanent storage of at least one first additional table for indices that are assigned to respective product codes, in which the product codes are stored ascendingly or consecutively in a column. The table also includes a second column wherein, in parallel to the product codes stored in the first column, indices for the product description are stored. A further memory range is provided in the program memory or in the programmable memory for permanent of semi-permanent storage of a second table for product descriptions, which are assigned to the respective indices determined from the first table. The microprocessor is programmed to evaluate the mail-item-related data values stored in the working memory by means of the table stored in the program memory or the programmable memory, so as to automatically determine a product code and a product description that are applicable to a particular service that is desired to be used, and that has been entered via the keyboard. The microprocessor also automatically determines, and supplies as an output, the necessary text for the product description for generating a printed copy memorializing usage of the aforementioned service.

### BACKGROUND OF THE INVENTION

1. Field of the Invention

The present invention concerns an apparatus for automatic determination of a product description for display by means of a mail-processing device, such as for use in postage meter machines, postal scales, mail shipping systems or personal computer (PC) postage meters that are supported by a PC and other mail-processing devices.

2. Description of the Prior Art

A postage meter machine is known from European Patent 493 948 that can print the shipment type as a separate optional imprint from the postage imprint or co-print it in an integrated manner and which is equipped with a number of registers in a secured module for storing accounting data that relate to the usage of the postage meter machine for applying postage to articles.

A first set of registers relates to a special first service and a second set of registers relates to a special second service, the special services being selectable via an input unit and the accounting data of the selected service being updated. However, only certain services are recorded for invoicing. These invoices do not provide the carrier with sufficient information about the customer behavior.

Some postal authorities/postal carriers now require (or promote using price incentives) the users to make print-outs about operations stored in the postage meter machine, for inclusion on documents (waybill) accompanying a mail stack/cargo or over a time period, i.e., to prepare invoices or statistics or receipts for any reloading operation that occurred for increasing the credit balance. Predicting the customer behavior would also be of interest to future postal carriers that will offer new mail services that then have to be invoiced separately. According to European Application 285 956, a postage meter machine is equipped with a special operations memory and with a connector for an external printer. The user is expected to search out and print only certain data from the stored periodic record of all of the data. To do this, the user has to prepare a separate printer and possibly also reserve a large amount of time to search out and print the data.

New postage meter machines offered by Francotyp-Postalia AG & Co. KG use digitally operating printing units. For example, the T1000 and JetMail® postage meter machines from Francotyp Postalia AG & Co. KG were the first to have a thermotransfer printer or rather an inkjet printer. This means it is basically possible to also print addresses and other information on a filled letter in the region of the postage stamp that are related to a service.

Thus, imprints can be printed during postage application in order to designate the shipment type or form. The form of storage can be adapted to the needs of a multiplicity of users of one and the same postage meter machine. For example, in some meters a class formation in the form of cost centers is used, the cost centers being allocated to individual user groups.

For printing reports even without a separate external printer, German OS 42 24 955 discloses a method and an arrangement for internal cost center printing. The printouts that can be produced for each cost center contain listings of mail usage of the postage meter machine that can be subdivided by optional prints. The saving of the additional printer is advantageous for the user. It is not reasonable, however, to expect the user to repeatedly print out lists with data on the usage of the postage meter machine when so requested by the postal carrier or rather data center, the reason being that while printing lists of cost center data using the postage meter machine's internal print head, it is naturally impossible to apply any postage.

The postal authorities in some countries require product code entry (PCE) for future mail-processing devices. The current PCE requirements differ in different countries. In Germany, 561 ProductCode categories are specified; in the Netherlands, 11 or 25 or 151 ProductCode categories are specified; and in Canada, 16 or 48 or 72 ProductCode categories are specified. This necessitates an additional entry by the operator. The product categories specified by the mail service should be recognized following manual input by the mail-processing device and stored within the context of the data determination for mail class statistics (CoM=Class of Mail). The so-called product code entry (PCE) requires corresponding changes in the user interface and in terms of the user prompting for a mail-processing device. The postal authorities in some countries require additionally a weight class entry that also entails an additional operating expense for the operator.

### SUMMARY OF THE INVENTION

An object of the present invention is to automate the product code entry to the largest possible extent and in this process to generate at least one text line for a product description in the printed copy.

The above object is achieved in accordance with the invention by a mail-processing device that undertakes automatic generation of a product description, the device having a programmable memory, a program memory, a working memory, a keyboard with operating elements, and a microprocessor, wherein either the program or the programmable memory has a memory range containing a program for evaluating mail-item-related data values stored in the working memory for permanent of semi-permanent storage of those values, a memory range or semi-permanent storage of at least one first additional table for indices that are assigned to respective product codes, wherein the product codes are stored ascendingly or consecutively in a column. The table also includes a second column wherein, in parallel to the product codes stored in the first column, indices for the product description are stored. A further memory range is provided in the program memory or in the programmable memory for permanent of semi-permanent storage of a second table for product descriptions, which are assigned to the respective indices determined from the first table. The microprocessor is programmed to evaluate the mail-item-related data values stored in the working memory by means of the table stored in the program memory or the programmable memory, so as to automatically determine a product code and a product description that are applicable to a particular service that is desired to be used, and that has been entered via the keyboard. The microprocessor also automatically determines, and supplies as an output, the necessary text for the product description for generating a printed copy memorializing usage of the aforementioned service.

The operator of a mail-processing device already enters shipping information via a keyboard that is needed for computing postage as well as for generating optional prints. Based on these manual entries, in accordance with the invention an apparatus automatically determines the product code and stores the product code in a memory of the mail-processing device. The apparatus can be operated according to the invention in order to automatically carry out a generation of at least one text line for a product description in the printed copy. A postage table is extended corresponding to the country-specific postal requirements so that, based on the product code, it is possible to also determine product descriptions which must be contained in the printed copy according to postal requirements. Additional tables are provided in order to determine an index from the product code. This index serves, in a second table, to find the necessary text for the product description. Using a further table, based on the set shipping parameters, text strings also can be found which must likewise appear in the printed copy.

The apparatus uses the microprocessor, working memory, program memory and receiving unit that are already present in the mail-processing device for loading and storing current table values and data which are related to the entry as well as a display and a keyboard with operating elements. The apparatus is, for example, part of a postal scale (postage calculating scale) to which a postage meter machine is connected via an interface. The automatically determined product code and possibly weight class code are buffered in the working memory of the postal scale and then transmitted via the interface to the postage meter machine and stored there in a non-volatile manner until queried by a remote data center. In another configuration, the apparatus can be part of a postage meter machine with integrated postage calculator or of a similar mail-processing device.

According to the invention, moreover, a programmable memory for tables, a working memory for the data values of the shipping parameters of a mail item and means for setting a PCE operating mode for automatic product code input are provided and the microprocessor is programmed by a program stored in the program memory to switch to the operating mode. Either via the interface or via an operating element, the setting of the PCE operating mode, e.g., during the initiation or after switching on the device or system, is carried out by the microprocessor responding to the signals delivered to the device via the interface or via an operating element.

In particular, there occurs a non-volatile storage of a start address in a programmable memory of at least one first table, which has several columns, it being possible for the columns to contain data values as well as pointers to further tables.

The program contains corresponding instructions and the microprocessor is programmed to generate screen images at least for entries of shipping parameters for displaying the entry possibilities on the display and for transient storage of data values of the entries in the working memory. Such data values, e.g., weight values, can be delivered via the interface as well as entered manually. Via the aforementioned first table, access occurs to further tables if, during evaluation of the data values, which valid row of the table is determined whose data values correspond to the data values stored in the working memory. Separately or in combination with the determination of the product code, a weight class code can also be determined and stored in a non-volatile manner in a memory range for usage data in the programmable memory. The weight class code can be linked to the receiving unit that is equipped for loading tables into the programmable memory. The invention thus employs at least one first table with which associated further tables such as a weight table, product code table, tables with descriptive text and text strings as well as a weight class table can be associated.

### DESCRIPTION OF THE DRAWINGS

FIG. 1 is a block diagram of the inventive apparatus in a mail device.

FIG. 2 is a flowchart for operating the apparatus in accordance with the invention.

FIG. 3 illustrates a franking imprint printed in accordance with the invention.

FIG. 4 is a flowchart for a subroutine automatic determination of product description and text strings in accordance with the invention.

FIG. 5 shows listings for the steps 103, 104 and 105 in FIG. 4.

### DESCRIPTION OF THE PREFERRED EMBODIMENTS

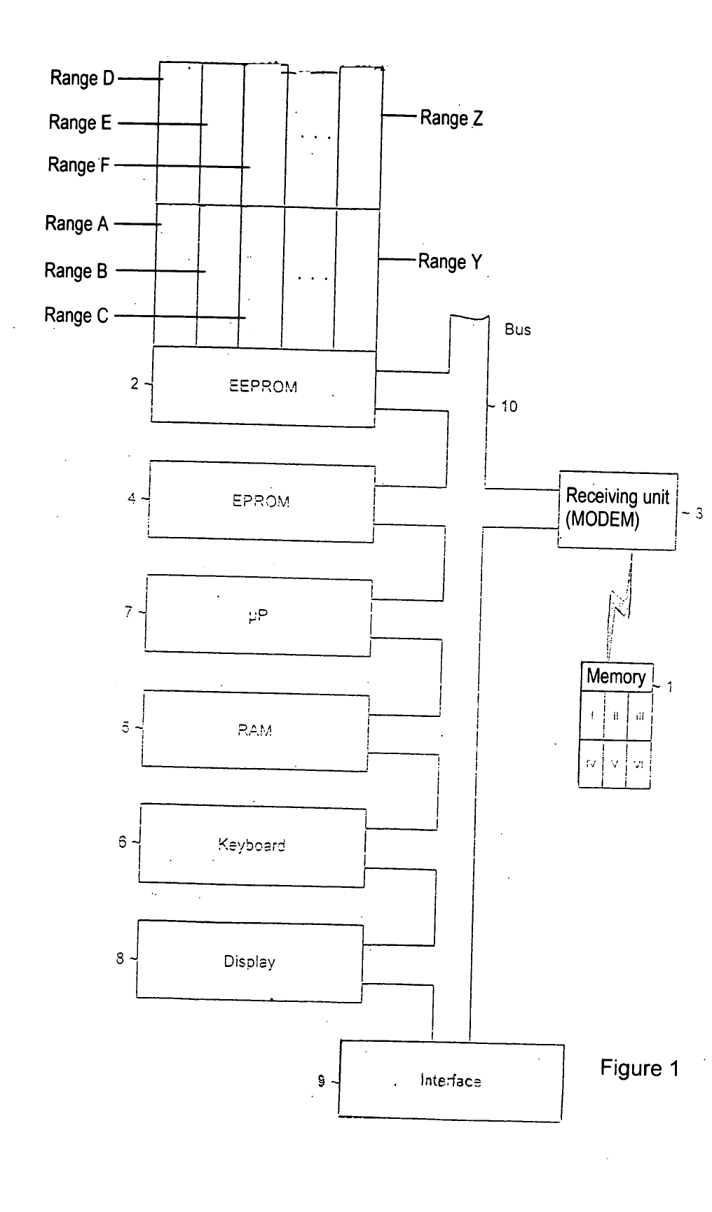

FIG. 1 shows a block diagram of the apparatus in the mail device. The mail device has a programmable memory 2 (such as an EEPROM) which can be connected in an operating manner to a receiving unit 3 such as a modem and to a program memory 4 (such as an EPROM), a working memory 5 (such as a RAM) and to an operating element 6 (such as a keyboard) and a microprocessor 7. The receiving unit 3, the working memory 5, the operating element 6 and the microprocessor 7 can be components of a postage meter machine, an electronic postal scale or a PC-supported mail shipping system. Such machines are generally equipped with a display unit 8 and an interface 9. The above components are interconnected, for example, via a bus 10. In the programmable memory 2, at least one table for automatic product code entry is stored and the microprocessor 7 is programmed by a correspondingly associated application program:
For row-by-row searching through the first and second columns of the at least one first table and for invoking program instructions
For comparison of the data values with the data values of the entries which are stored in the working memory 5, corresponding to the defaults for valid shipping parameters which are present stored in the first and second columns of the at least one first table in the form of data sets
For evaluation of the instructions in the remaining columns of the at least one first table, the evaluation taking place for valid shipping parameters in only that row of the at least one first table to which the data values in the working memory 5 correspond.

In another variant (not shown), the receiving unit 3 can be connected also directly via the interface 9.

Via the interface 9, (in a manner not shown) a scale can be connected to a postage meter machine or a PC-supported mail shipping system for automatic weight entry. Alternatively, weight entry can be carried out manually using operating elements 6.

In a further variant (not shown), the receiving unit 3 can be connected also indirectly via the interface 9. Thus, for example, the co-usage of a modem of the postage meter machine by a scale is possible in order to load postal fee tables into the memories of the postal scale. The details of such a interconnection follow from European Patent 724 141.

The programmable memory 2 can be connected for loading tables in an operating manner via the receiving unit 3 to an external memory 1. The receiving unit 3 is preferably an analog or digital modem. Alternatively, the receiving unit can be a drive and the external memory 1 can be a CD or DVD. In a further alternative, the receiving unit 3 can be a chip card reader and the external memory a chip card. It is also possible for the receiving unit 3 to be a memory stick interface and the external memory a memory stick. It is only necessary that a suitable data carrier and associated receiving unit 3 be present.

The data carrier (memory 1) has in one of the memory ranges an application program for automatic product code entry and for generation of screen images which program is suitable at least for entries of shipping parameters for displaying the entry possibilities on the display 8. At least the first table is stored in the first memory range I and further tables in further memory ranges II, III, . . . , VI to which access is enabled via the application program, the at least one first table containing at least columns for data values of correspondingly valid shipping parameters as well as for pointer(s) to a weight table, for pointer(s) to a product code table.

In an alternative variant, the application program can be present stored already from the factory in the program memory 4. The memory of the program memories 4 forms a permanent memory and the programmable memory forms a semi-permanent memory.

For automatic generation of a product description by means of a mail-processing device, it is provided that in the program memory 4 or programmable memory 2:
A memory range D is provided with a program for evaluating mail-item-related data values stored in the working memory 5 for their permanent or semi-permanent storage
A memory range E for permanent or semi-permanent storage of at least one first additional table for indices which are assigned to the respective product codes wherein the product codes are stored ascending or consecutive in a column and in parallel to this in a second column the indices for the product descriptions
A memory range F is provided for permanent or semi-permanent storage of a second additional table for product descriptions that are assigned to the respective indices determined from the first table.

The microprocessor 7 is programmed by the program for evaluating the mail-item-related data values stored in the working memory 5 by means of a table stored in the programmable memory 2 in order to automatically determine a product code and the product description applicable to the service product from a table stored in the memory 2, 4 with product descriptions based on the product code as well as to output the necessary text for the product description for generating printed copies.

The microprocessor 7 is programmed, for example, by a program stored in the program memory 4 in order to determine an index from the product code as well as to find via the index in the second table the necessary text for the product description. Moreover, a memory range T is provided for permanent or semi-permanent storage of at least one third additional table with text strings which are assigned to the respective indices. The microprocessor 7 is programmed by a program in order to determine the text strings based on the set shipping parameters from the table and to output them for printing out to a printing device.

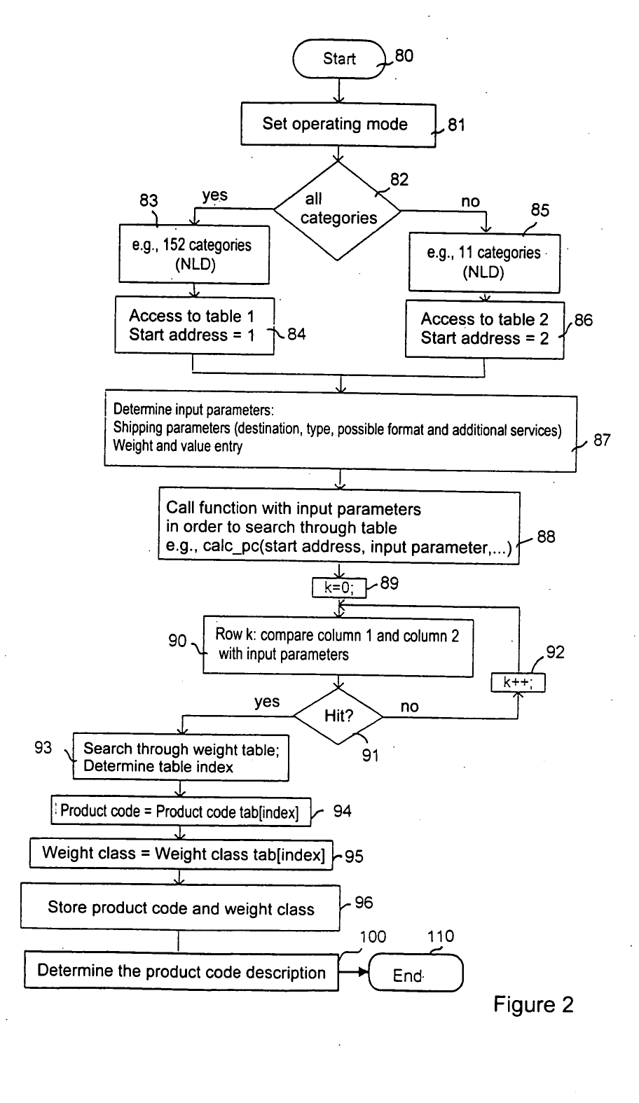

FIG. 2 shows a flowchart for operating the apparatus that automatically determines based on the shipping parameters set by the operator a valid product code and a corresponding weight class code. After the start 80, the operating mode has to be set once (step 81), a selection as to whether a table with all categories of product code or with a limited number of categories of product code. An advantage is that an additional manual entry of product code and weight class code for the respective mail item by the operator is unnecessary. The postage machine determines the setting in step 82 depending on the selection. For example, if it is determined in step 82 that all of the categories should be used or rather not used, then a branch is made in step 83 or rather in step 85 to a corresponding program which makes access to a first table 1 or rather a second table 2 (in step 84 or rather 86).

Automation requires the operator—as usual—to set the mail-item-related shipping parameters in step 87, but further manual entries are unnecessary and the determination of the product code and weight class code runs automatically in the background (starting with step 88). The determined quantities of mail-item-related product code and weight class code are transferred at intervals of time automatically to the data center for evaluation. Without additional entries, the operator can use the benefits of the postal services that are offered to the operator if the operator is participating, for example, in the NetSet project in the Netherlands and statistical data are transferred to the data center.

The operator sets his shipping parameters on a postal scale or on a postage meter machine. The shipping parameters are a combination of shipping destination, shipment type, possibly shipment format and any additional capabilities that might be set. From a valid combination of shipping parameters, the product code and the weight class code are determined.

While the operator sets the shipping parameters, it is automatically checked whether the set shipping parameters are valid, i.e., allowed in postal terms. With the aid of the postal scale, the weight of the shipment is determined. There exists additionally the possibility to input the weight via the keyboard if the weight range of the shipment type is greater than the weight range of the scale. For example, if a 5 kg scale is available, but the weight range of the shipment type allows a weight up to 20 kg, the operator has the possibility to enter the weight of his shipment via the keyboard (e.g., 15 kg). For additional services which require, say, the entry of a value (e.g., insured letter), the operator is requested during the selection of such an additional service to enter the value of the shipment via the keyboard.

The set shipping parameters, the possibly entered value and the weight of the shipment form the input parameters for determining the product code and weight class. In the program memory, the operating software of the postal scale or the postage meter machine or mailing device is stored. The program memory preferably is designed in a plug-in format, resulting in easy exchangeability and thus adaptation to the different mail requirements in different countries. The operating software delivers instructions for a function of the microprocessor in order to search through a separately stored table with the aid of the input parameters (shipping parameters, weight, value entry) and from this determine the product code and possibly the weight class code.

Alternatively, a data carrier for the programming of the apparatus contains an application program for automatic product code entry in one of its memory ranges and the application program can be loaded into a memory range of the programmable memory 2 and stored in a non-volatile manner. The programming takes place oriented especially toward the products or services of the postal carrier in order to form a certain combination of shipping parameters, which are stored in the working memory, and to compare them with one of the possible products or rather services of the postal carrier. Here, a separately stored table is also searched and from this the product code and possibly the weight class code are determined.

A separate table of this sort, which stores the valid product code for each possible combination of shipping parameters, is accommodated in the separate memory, for example, in memory range II. A separate memory can be a data carrier or rather an external memory medium 1 with a multiplicity of memory ranges I to VI. The above named table is loaded into a memory (e.g., memory 2) in the postal scale or postage meter machine. The table alternatively can be burned-in during the manufacture of the postal scale or postage meter machine in its program memory (memory 4). The operating software or the application program knows the memory location and the start address of the table and can access it in this manner.

A product code table will be explained in greater detail based on a table intended for the Netherlands. This table consists of seven columns:
Column 1: Contains the valid shipping parameter combination that must be set in order to select this row of the table
Column 2: Contains a mask of shipping parameters in order to possibly exclude this row as a hit
Column 3: Contains the maximum value of an insurance total or rather of the value of the shipping item. This value is zero if a value for the shipping selection is not necessary.
Column 4: Contains a pointer to a weight table. This weight table contains all of the weight graduations for the set shipping parameters.
Column 5: Contains a pointer to the product code table.
Column 6: Contains a pointer to the weight class table.
Column 7: Contains a pointer to a special function that is possibly still to be realized. This value can also equal ZERO.

The input parameters for the computation and the corresponding country- or carrier-specific computation function are invoked in step 88, and a row counter is reset to zero (k=0).

Based on the verification of column 1 and column 2, in step 90 a row k is searched for with a valid hit within the table. In each column, a 32-bit data set is stored. That row which supplies the first valid hit is used for further evaluation. If no hit is determined in query step 91, then in step 92 the row counter status is modified (e.g., incremented) and a branch back to step 90 is made. The row counter status remains unchanged in case of a hit and column 3 is evaluated. It is checked whether the entered insurance sum or value of the shipping item is less than or equal to the maximum value indicated in column 3. If that is not the case, the following rows are investigated for the next hit and the row counter status is changed. The row counter status is changed further.

Otherwise, there is a hit and a pointer in column 4 of that row which provides the valid hit points to a certain at least one weight table. The later is stored in a separate memory range B of the non-volatile memory 2 (EEPROM). A branch is then made to step 93 the weight table and determine a weight index.

That weight table to which the pointer in column 4 points is searched until the weight value in the table is found which is closest to the weight determined by the scale or the weight value which was entered via the keyboard, i.e., the next higher weight value in this table is valid. The weight table stores the weight graduations for which different product codes or weight classes apply. The weight graduations might look as follows:
Weight table=0, 20, 100, 250, 500, 750, 1000, 1500, 2000, 5000

It is investigated into which graduation of the weight table the determined weight value fits. If an entry was found, from this the associated table index is determined which indicates at which location of the table the suitable entry was found.

Subsequently, the (at least one) product code table to which the pointer in column 5 points is investigated in step 94. With the aid of the table index found in the weight table, the corresponding product code is determined in the product code table.

In step 95, the already determined table index can also possibly serve, in the weight class table to which the pointer in column 6 points, to determine the corresponding weight class.

Column 7 is currently reserved for possible future applications.

The product code and the weight class code are passed back to the invoking function as parameters and are stored in step 96. If within the table no hit is found which ensues from the shipment destination, shipment type, possibly the shipment form and additional services, then a default product code is transferred back to the invoking function. This default product code is defined depending on the postal service's specification (e.g., in the Netherlands=9999).

Thus, the product code table contains an entry only for the shipping parameters for which a product code must be determined also according to the postal specification. Moreover, there are shipping parameters that are intended to produce a product code that is to be allocated to the category “Miscellaneous”. For these shipping parameters, there are no separate entries in the table. At the end of the table, there is an entry that is read if no hit was found previously. This entry then points to the product code table with the product code for “Miscellaneous”.

The above-described solution was implemented specially for the Netherlands. The table can look differently for other country-specific variants. Then, it could be the case that an error code must be produced if no suitable hit was found for the set shipping parameters in the table.

A postal scale, e.g., of the type FlexiScale®, determines, based on the set shipping parameters such as the destination, type, possibly the format and form, a postage value and the associated product code and the corresponding weight class code. The product code and the weight class code are transmitted along with the postage value to the postage meter machine and stored there until the data are queried by a remote data center.

A static scale with its postal scale function is integrated into a common housing in the postage meter machines Jetmail®, Mymail® and Ultimail® that are commercially available from Francotyp-Postalia AG & Co. KG. Within the context of the FRANKIT requirements of Deutsche Post AG, a product code must also be processed which is enabled in the country-specific variant for Germany for postage meter machines of the above-described type. This does not differ in basic terms, however, from a product code specified by the postal authority in the Netherlands so that the flow of process steps in FIG. 2 can be basically retained also for Germany. The same is true also for further countries which postal authorities or private postal service providers will require the usage of a product code in the future.

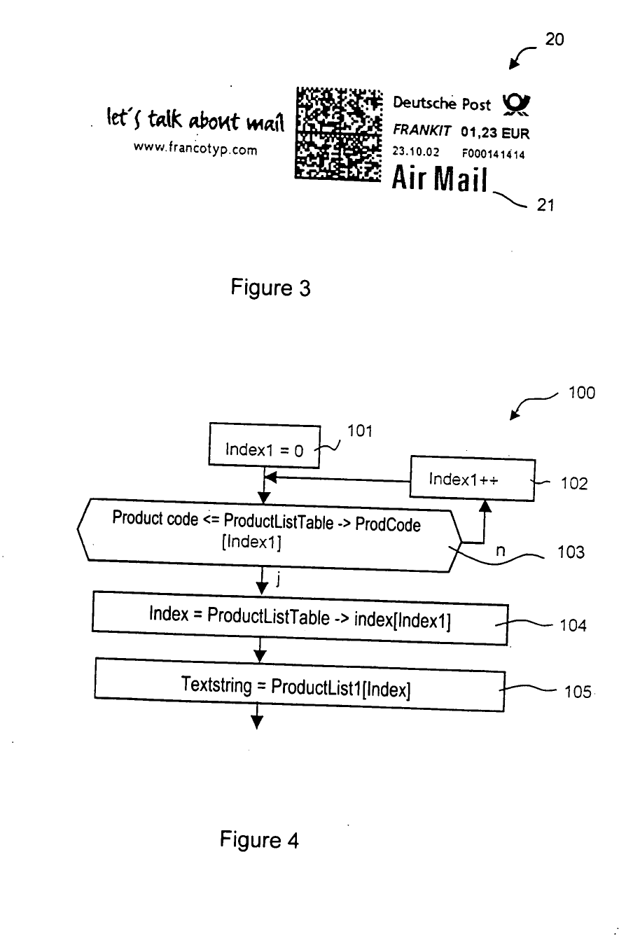

FIG. 3 shows a printed franking imprint 20 that contains at least one row 21 for the product description or rather text strings for the shipping parameters. In the shown example, the corresponding row contains “AIR MAIL”, which is automatically generated and printed during the printing along with the remaining postage stamp data on a mail item.

According to FIG. 2, the product code and the weight class are stored in a penultimate step 96. Before that, further steps 80-95 are executed, including steps for evaluating the mail-item-related data values stored in the working memory 5 by means of a table stored in the programmable memory 2 in order to determine the product code. A further subroutine 100 for determining the product code description runs before the end 110, as shown in the flowchart of FIG. 4.

FIG. 4 shows a flowchart for automatically determining the product description or rather text strings. In a first step 101, the microprocessor 7 is programmed by the program Set Index1=0 and then a step 103 is reached for determining whether a certain Index1 corresponds to the product code stored in the penultimate step. In the table, the product codes ascending associated with a corresponding ascending value of Index1, or are stored consecutively in a column and in parallel to this in a second column the indices for the product descriptions. Via a further step 102, a branch back to the step 103 is made until in the step 103 the desired index has been determined. In the further step 102, the next Index1 is determined, for example, through incrementation.

A permanent or semi-permanent storage of a second additional table of this sort for product descriptions is provided in a memory range F. Corresponding text strings are assigned to the respective indices determined from the first table. The product description relevant to the service product from a table stored in the memories 2 and 4 with product descriptions based on the product code is thus automatically determined in a the step 105 and displayed on a display. The necessary text for the product description for generating printed copies is generated in the same or a similar manner and then inserted into the remaining print image. A memory range (Y) for permanent or semi-permanent storage of at least one third additional table is provided for such text strings which are supplied as an output for printing to a printing device.

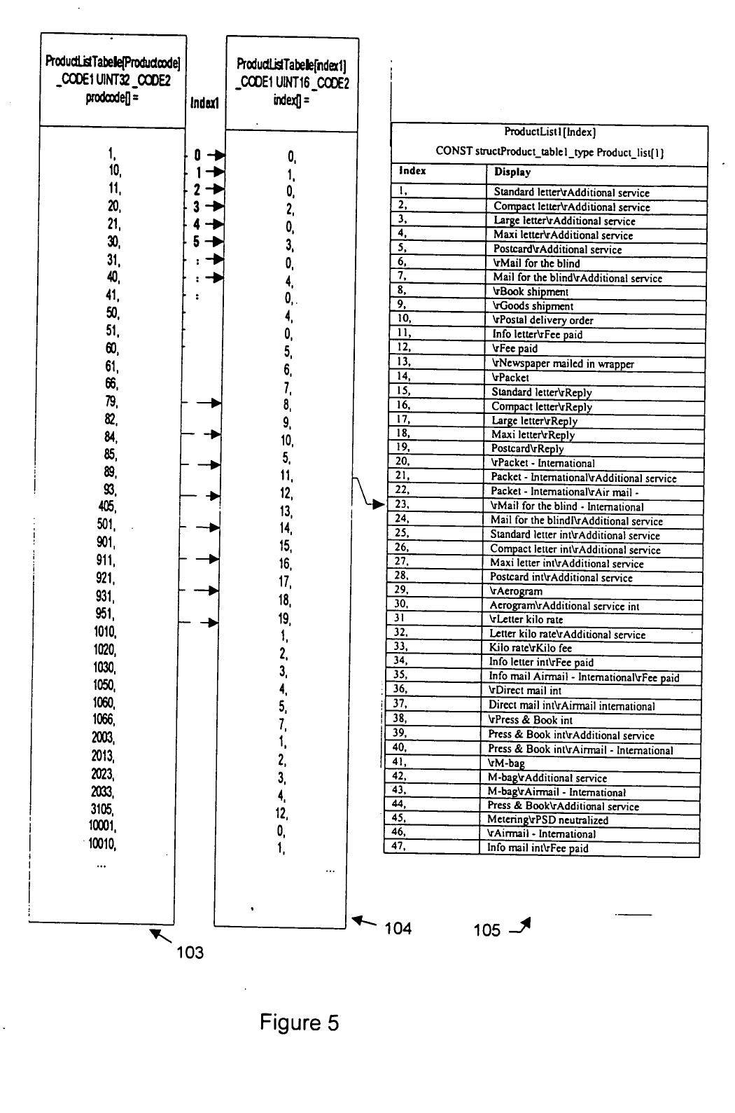

FIG. 5 shows a list suitable for Germany of the step 103, 104 and 105 of the flowchart according to FIG. 4. An associated (not shown) Index1 is determined for the determined product code (e.g., product code=15) which is less than or equal to the entered product code (e.g., product code=20) in the table. For example, a determined product code=15 in the list according to FIG. 5 yields Index1=3.

In step 104 of the flowchart according to FIG. 4, with the determined Index1 (e.g., Index1=3), the next index value (namely, Index=2) is automatically determined using the list for step 105 shown in FIG. 5. In the step 104, the determined index is stored. The two lists according to steps 104 and 105 are to be understood as columns of a first additional which is stored in memory range E.

In step 105 of the flowchart according to FIG. 4, for example, Index=2 was determined using the table according to FIG. 5 and yields, after entry into the list step 106 of FIG. 5, the corresponding string for the additional letter service (BZL), e.g.: An Index=2 thus leads to the display text=Compact letter \r Additional service. The character \r stands for New Line. If a value of zero is determined for Index1, then no BZL text string is printed.

Although modifications and changes may be suggested by those skilled in the art, it is the intention of the inventor to embody within the patent warranted hereon all changes and modifications as reasonably and properly come within the scope of her contribution to the art.

1. A mail-processing device comprising:
a microprocessor;
a keyboard with operating elements connected to said microprocessor for entering a designation of a service product into said microprocessor;
a working memory accessible by said microprocessor containing mail-item-related data values;
a programmable memory and a program memory accessible by said microprocessor;
in at least one of said program memory and said programmable memory, a first memory area containing a program for evaluating said mail-item-related data values stored in the working memory to cause said mail-item-related data values to be permanently or temporarily stored, a second memory area containing a first table for indices respectively assigned to different product codes, said product codes being ascendingly or consecutively stored in said table in a column and said table having a second column, in parallel with said first column, containing indices for different product descriptions, and a third memory range for storage of a further table for said product descriptions respectively assigned to said indices in said second column; and
said microprocessor being programmed by said program for evaluating the mail-item-related data values stored in the working memory by accessing said table containing said first and second columns to automatically determine a product code and a product description for said service product, and to supply as an output a text for said product description for generating a printout thereof.

2. A mail-processing device as claimed in claim 1 wherein said microprocessor is programmed by said program to determine the index for the product code and to locate the index in said further table for said product description.

3. A mail-processing device as claimed in claim 1 comprising, in at least one of said program memory and said programmable memory, a fourth memory area for storage of an additional further table containing text strings assigned to the respective indices, and wherein said microprocessor is programmed by said program to determine a text string from said additional further table dependent on shipping parameters for said service product and to supply said text strings in said output.

4. A mail-processing device as claimed in claim 1 wherein said program memory is a permanent memory and wherein said programmable memory is a semi-permanent memory.
